(19) United States
(12) Patent Application Publication
(10) Pub. No.: US 2010/0113143 A1
(43) Pub. Date: May 6, 2010

(54) SECURING MOBILE WAGERING GAME MACHINES

(75) Inventors: Mark B. Gagner, West Chicago, IL (US); James M. Rasmussen, Chicago, IL (US); Craig J. Sylla, Round Lake, IL (US)

Correspondence Address: WMS GAMING (DELIZIO GILLIAM);C/O DELIZIO GILLIAM, PLLC, 15201 MASON ROAD, SUITE 1000-312, CYPRESS, TX, 77433, US

(73) Assignee: WMS Gaming ,INC., Waukegan (US)

(21) Appl. No.: 12/532,760

(22) PCT Filed: Apr. 21, 2008
(86) PCT No.: PCT/US2008/061000

§ 371 Date: Sep. 23, 2009

Related U.S. Application Data
(60) Provisional application No. 60/913,676, filed on Apr. 24, 2007.

(51) Int. Cl. G06F 21/20

(52) U.S. Cl. 463/29; 463/42; 463/43

(57) ABSTRACT

Systems and methods for securing mobile wagering game machines are described herein. In some embodiments, a method includes detecting, in a mobile wagering game machine, a wager associated with a wagering game. The method can also include presenting the wagering game and detecting a security breach of the mobile wagering game machine. In some embodiments, after detecting the security breach, the method includes deleting authentication information stored in the mobile wagering game machine.

### RELATED APPLICATIONS

This application claims the priority benefit of U.S. Provisional Application Ser. No. 60/913,676 filed Apr. 24, 2007.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2008, WMS Gaming, Inc.

### FIELD

Embodiments of the inventive subject matter relate generally to wagering game systems, and more particularly to security for mobile wagering game machines.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### SUMMARY

In some embodiments, a method comprises detecting, in a mobile wagering game machine, a wager associated with a wagering game; presenting the wagering game; detecting a security breach of the mobile wagering game machine; and after detecting the security breach, deleting authentication information stored in the mobile wagering game machine.

In some embodiments, the mobile wagering game machine includes a shell encapsulating electronic components, and wherein the detecting a security breach includes detecting damage to the shell.

In some embodiments, the authentication information includes a private key for encrypting communications associated with the wagering game.

In some embodiments, the detecting a security breach includes detecting a signal from one or more of the group consisting of contacts, a photo sensor, an enclosure, and a serpentine wire.

In some embodiments, the method further comprises after detecting the security breach, damaging electronic components in the mobile wagering game machine by overloading the electronic components with power.

In some embodiments, the mobile wagering game machine includes a plurality of power sources, and wherein one of the plurality of power sources supplies power for the presenting the wagering game, and wherein another of the power sources supplies power for the deleting the authentication information.

In some embodiments, a mobile wagering game machine comprises a shell encapsulating components of the mobile wagering game machine, the components includes, a gaming module configured to present wagering games upon which monetary value can be wagered; and a security module includes, a memory including authentication information, a security controller configured to determine whether the shell is secure and to render the security module inoperable if the shell is not secure.

In some embodiments, the security module further includes a power source configured to provide power to the security controller.

In some embodiments, the security controller receives a signal originating from one or more of the group consisting of contacts, a photo sensor, a serpentine wire molded into the shell, and an enclosure encapsulating the gaming module.

In some embodiments, the security controller is further configured to periodically indicate that the shell is secure.

In some embodiments, the security controller is further configured to respond to security inquiries from a central server.

In some embodiments, the security controller is configured to render the security module inoperable by deletion of the authentication information.

In some embodiments, the security controller is further configured to use the power to erase the authentication information.

In some embodiments, the power is enough to destroy the security controller.

In some embodiments, the authentication information includes a private key with which to encrypt transmissions associated with the wagering game.

In some embodiments, the gaming module is further configured to encrypt a first player credential with a first private key, and wherein the security module is further configured to encrypt a second player credential with a second private key.

In some embodiments, a mobile wagering game machine comprises means for encapsulating components of the mobile wagering game machine, where the components include: means for presenting wagering games upon which monetary value can be wagered; means for detecting that the means for encapsulating is not secure; means for powering the means for detecting, wherein the means for powering does not provide power to the means for presenting wagering games.

In some embodiments, the mobile wagering game machine further comprises means for notifying a wagering game server that the means for encapsulating is not secure.

In some embodiments, the mobile wagering game machine further comprises a means for storing authentication information; and a means for deleting the authentication information after detecting that the means for encapsulating is not secure.

In some embodiments, the means for detecting includes one or more selected from the group consisting of contacts, a photo sensor, and a serpentine wire.

In some embodiments, the means for presenting wagering games is encased in an enclosure.

In some embodiments, the mobile wagering game machine further comprises means for notifying the means for presenting that the means for encapsulating is not secure.

### BRIEF DESCRIPTION OF THE FIGURES

Embodiments of the invention are illustrated in the Figures of the accompanying drawings in which:

FIG. 1 is a block diagram illustrating a wagering game network, according to example embodiments of the invention;

FIG. 2 is a block diagram illustrating a mobile machine, according to some embodiments of the invention;

FIG. 3 is a block diagram illustrating security features for a mobile machine, according to some embodiments of the invention;

FIG. 4 is a block diagram illustrating a gaming module, according to example embodiments of the invention;

FIG. 5 is a block diagram illustrating a gaming module with multiple power sources, according to some embodiments of the invention;

FIG. 6 is a flow diagram illustrating operations for verifying the physical security of a mobile machine, according to some embodiments of the invention;

FIG. 7 is a flow diagram illustrating operations for verifying the physical security of a mobile machine, according to some embodiments of the invention;

FIG. 8 is a flow diagram illustrating operations for securing player credentials, according to some embodiments of the inventions; and

FIG. 9 shows an example embodiment of a mobile machine.

### DESCRIPTION OF THE EMBODIMENTS

This description of the embodiments is divided into five sections. The first section provides an introduction to embodiments of the invention, while the second section describes example operating environments and mobile wagering game machines. The third section describes example operations performed by some embodiments and the fourth section describes example wagering game machines in more detail. The fifth section presents some general comments.

### Introduction

This section provides an introduction to some embodiments of the invention. Wagering game machines are typically large stationary devices. However, some wagering game machines are lightweight handheld devices designed for mobility. This mobility enables players to play wagering games in a wide variety of casino settings, such as by a pool, in a sports book, in a restaurant, etc.

Mobile wagering game machines (hereinafter “mobile machines”) may be exposed to security risks not common to their stationary counterparts. For example, attackers can move mobile wagering game machines to clandestine locations that are free of casino security. Absent casino security, attackers can work with relative impunity. Some embodiments of the invention include security features that make mobile wagering game machines more resistant to attack. Some of the security features include: 1) components that monitor a mobile machine's physical integrity; 2) components that render a mobile machine inoperable if its physical integrity is compromised; and 3) components that encrypt player authentication credentials.

The following sections describe these and other features and embodiments.

### Operating Environment

This section describes an example operating environment and presents structural aspects of some embodiments. This section includes discussion about wagering game networks and mobile machines. Any of the components described below can include hardware, firmware, and/or machine-readable media including instructions for performing the operations described herein. Furthermore, any of the components described below can be integrated or divided.

### Wagering Game Networks

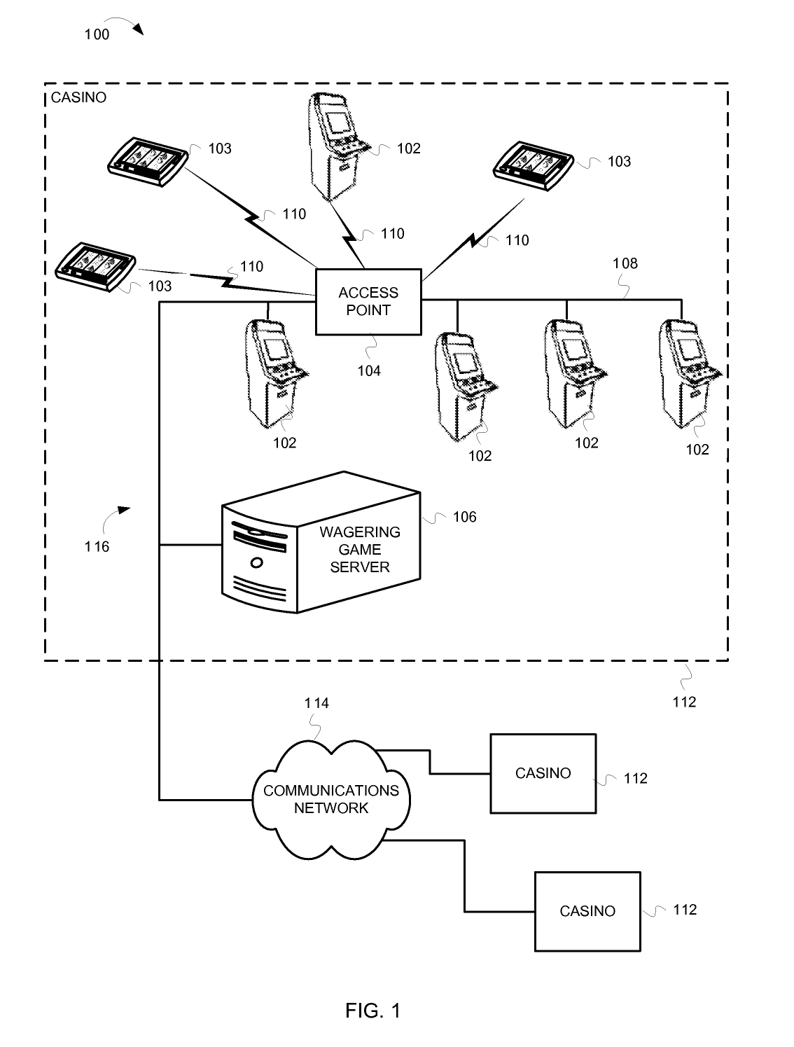

FIG. 1 is a block diagram illustrating a wagering game network, according to example embodiments of the invention. As shown in FIG. 1, the wagering game network 100 includes a plurality of casinos 112 connected to a communications network 114.

Each casino 112 includes a local area network 116, which includes an access point 104, wagering game server 106, mobile machines 103, and stationary wagering game machines (hereinafter “stationary machines”) 102. The access point 104 provides wireless communication links 110 and wired communication links 108. The wired and wireless communication links can employ any suitable connection technology, such as Bluetooth, 802.11, Ethernet, public switched telephone networks, SONET, etc. In some embodiments, the wagering game server 106 can serve wagering games and distribute content to the stationary and mobile machines 102 & 103.

The mobile machines 103 can move about the casino 112, whereas the stationary machines 102 typically remain at one location on the casino floor. Both the stationary and mobile machines 102 & 103 can present wagering games and other content. The mobile machines 103 can be primarily dedicated for use in presenting wagering games, or can include non-dedicated devices, such as mobile phones, personal digital assistants, notebook computers, etc.

In some embodiments, the stationary and mobile machines 102 & 103 work with the wagering game server 106 such that the stationary and mobile machines 102 & 103 can be operate as a thin, thick, or intermediate clients. For example, one or more elements of game play may be controlled by a mobile machine 103 (client) or the wagering game server 106 (server). Game play elements can include executable game code, lookup tables, configuration files, game outcome, audio or visual representations of the game, game assets or the like. In a thin-client example, the wagering game server 106 can perform functions such as determining game outcome or managing assets, while the mobile machine 103 can present a graphical representation of such outcome or asset modification to the user (e.g., player). In a thick-client example, the mobile machines 103 can determine game outcomes and communicate the outcomes to the wagering game server 106 for recording or managing a player's account.

In some embodiments, either the mobile machines 103 (client) or the wagering game server 106 can provide functionality that is not directly related to game play. For example, account transactions and account rules may be managed centrally (e.g., by the wagering game server 106) or locally (e.g., by the mobile machine 103). Other functionality not directly related to game play may include power management, presentation of advertising, software or firmware updates, system quality or security checks, etc.

In some embodiments, the wagering game network 100 can include other network devices, such as accounting servers, wide area progressive servers, player tracking servers, and/or other devices suitable for use in connection with embodiments of the invention. Any of the wagering game network components (e.g., the stationary and mobile machines 102 & 103) can include hardware and machine-readable media including instructions for performing the operations described herein.

### Mobile Machines

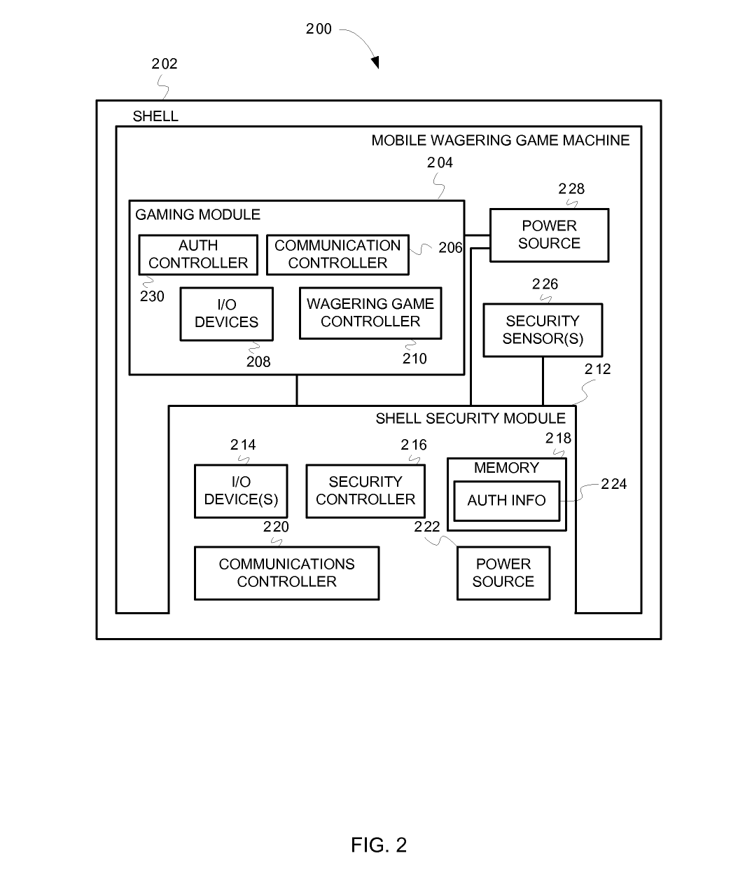

FIG. 2 is a block diagram illustrating a mobile machine, according to some embodiments of the invention. In FIG. 2, the mobile machine 200 includes a shell 202 that encapsulates a power source 228, security module 212, security sensor(s) 226, and wagering game module 204.

The power source 228 can supply power to the wagering game module 204 and security module 212 (e.g., when the mobile machine 200 is not connected to a wall socket). The power source 228 can include one or more batteries, such as lithium ion batteries, nickel-metal hydride batteries, nickel-cadmium batteries, etc.

The security module 212 can perform security operations, such as monitoring the mobile machine's physical security and encrypting player authentication credentials. If the mobile machine's physical security is breached (e.g., if the physical integrity of the shell 202 is altered), the security module 212 can render the mobile machine 200 inoperable and/or alert casino security. Also, as players sign-on, the security module can encrypt player credentials before passing them to the gaming module 204 or other components. In some embodiments, the security module 212 is molded into the shell 202.

As shown, the security module 212 includes a security controller 216, power source 222, memory 218, communication controller 220, and I/O device(s) 214. The security controller 216 can include any suitable microprocessor for performing security operations described herein. The power source 222 can include any suitable battery/batteries and it can power the security module's components after the power source 228 is drained. The memory 218 includes authentication information 224, which can include encryption keys, serial numbers, and/or other information. The I/O device(s) 214 can include a card reader, biometric information reader, keypad, etc. The communication controller 220 can include any communications technology suitable for communicating with the gaming module 204 or other devices (e.g., Universal Serial Bus, RS-232, Bluetooth®, etc.).

The security module 212 is connected to the security sensor(s) 226. The security sensor(s) 226 can detect events affecting the physical integrity of the shell 202. For example, the security sensor(s) 226 can include electrical contacts, light sensors, impact sensors, and other mechanisms for detecting whether the shell 202 has been opened.

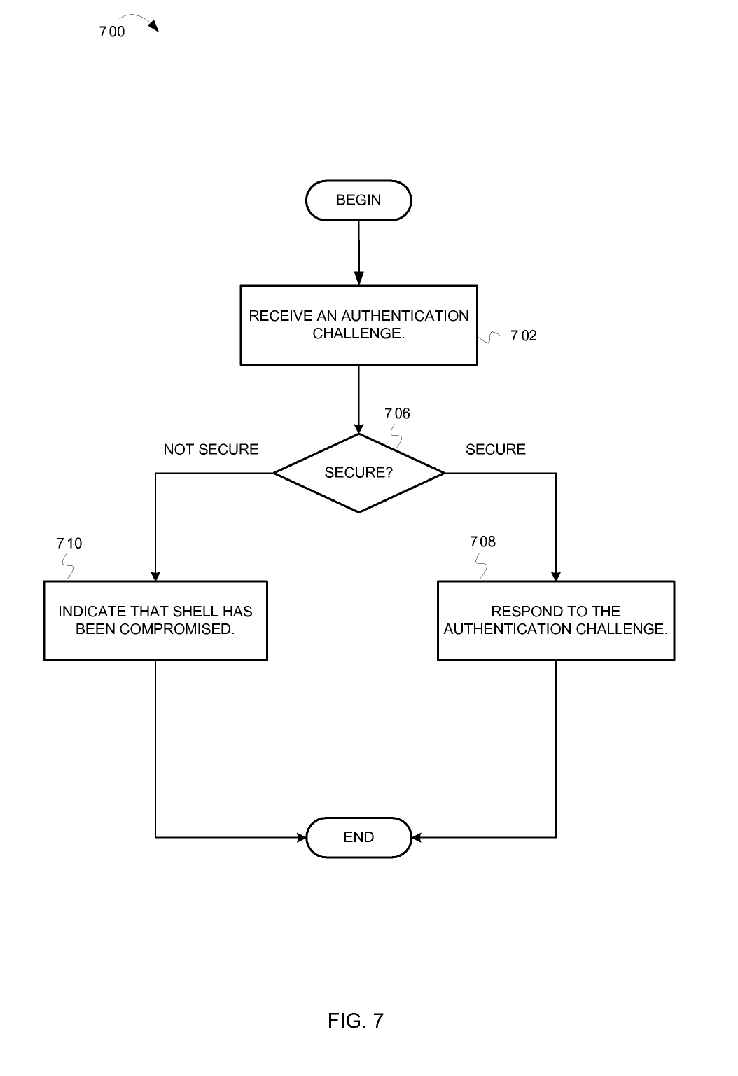

In addition to the above-noted security features, the mobile machine 200 can secure player credentials. In some embodiments, the mobile machine 200 authenticates players before allowing them to play games, etc. The authentication process can require that the mobile machine 200 provide a wagering game server (see FIG. 1) with two player credentials, such as information from an account card and a personal identification number (PIN). In some embodiments, the security module 306 can read information from the account card, while the gaming module 304 receives the PIN. The security module 306 can encrypt the account card information and pass it to the gaming module 304. The gaming module 304 can encrypt the PIN and forward both the PIN and account card information to the wagering game server for authentication. As a result, the player credentials are encrypted by different components using different private keys, making the player credentials safer from rogue code and/or other attacks. Operations for securing player credentials are described in more detail below (see discussion of FIG. 7).

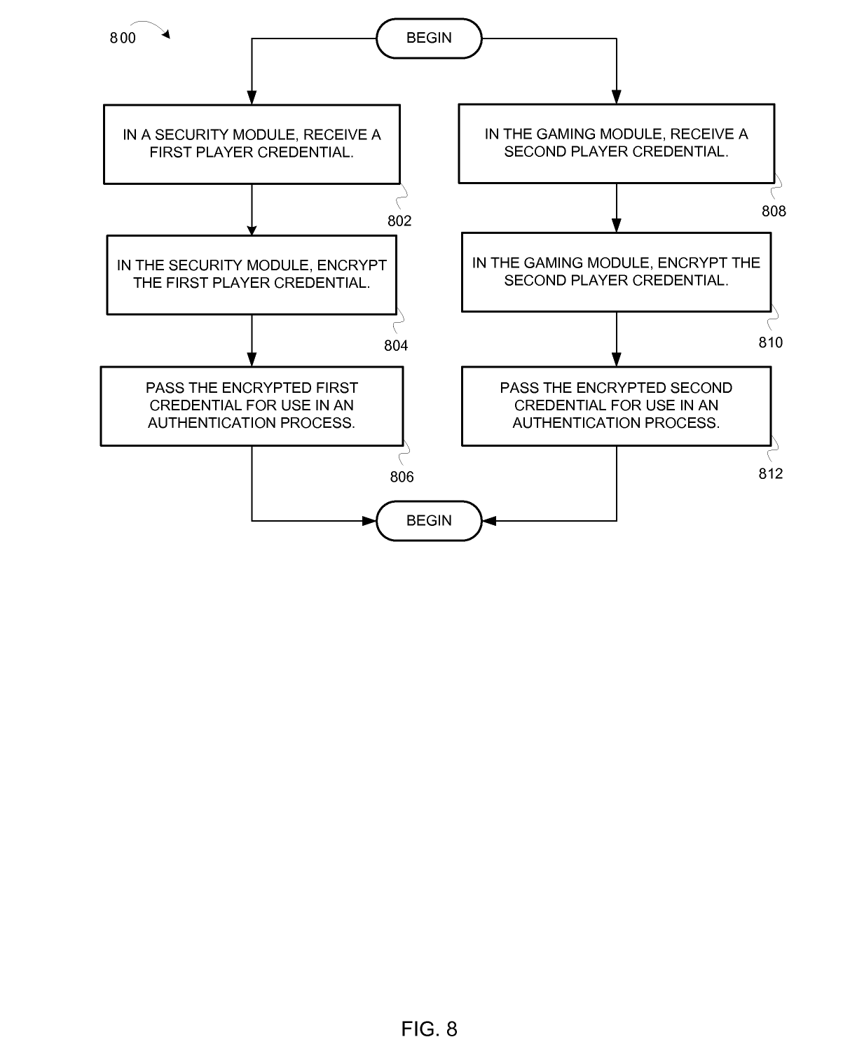

The mobile machine's gaming module 204 can facilitate presentation of wagering games and other content. As shown, the gaming module includes I/O devices 208, communication controller 206, authentication controller 230 and wagering game controller 210. The wagering game controller 210 processes wagering game content and presents wagering games. The I/O devices 208 can receive and present information associated with wagering games. In some embodiments, the I/O devices 208 can include a touchscreen, buttons, joysticks, etc. The communication controller 206 can include any suitable communication technologies that facilitate communications between: 1) the gaming module 204 and a wagering game server (see FIGS. 1); and 2) the gaming module 204 and the security module 212. Thus, the communication controller 206 can include Ethernet, 802.11g, USB, RS-232, Bluetooth ®, and other technologies. The authentication controller 230 can perform operations for authenticating users (see discussion of FIG. 8).

This section continues with a mobile machine that includes additional security features. Some of the security features enable mobile machines to detect whether their shells has been compromised.

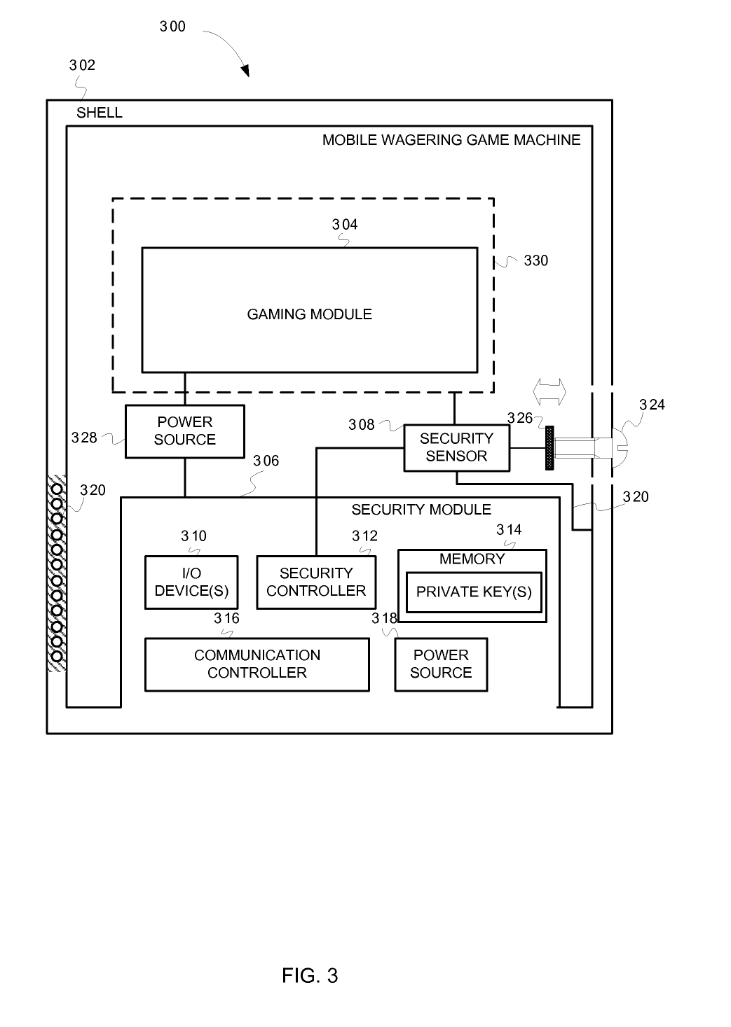

FIG. 3 is a block diagram illustrating security features for a mobile machine, according to some embodiments of the invention. In FIG. 3, the mobile machine 300 includes a shell 302 that encapsulates a gaming module 304, power source 328, security module 306, and security sensor 308. While FIG. 3 does not show the gaming module's components, they can include those shown in FIG. 2 or those described below.

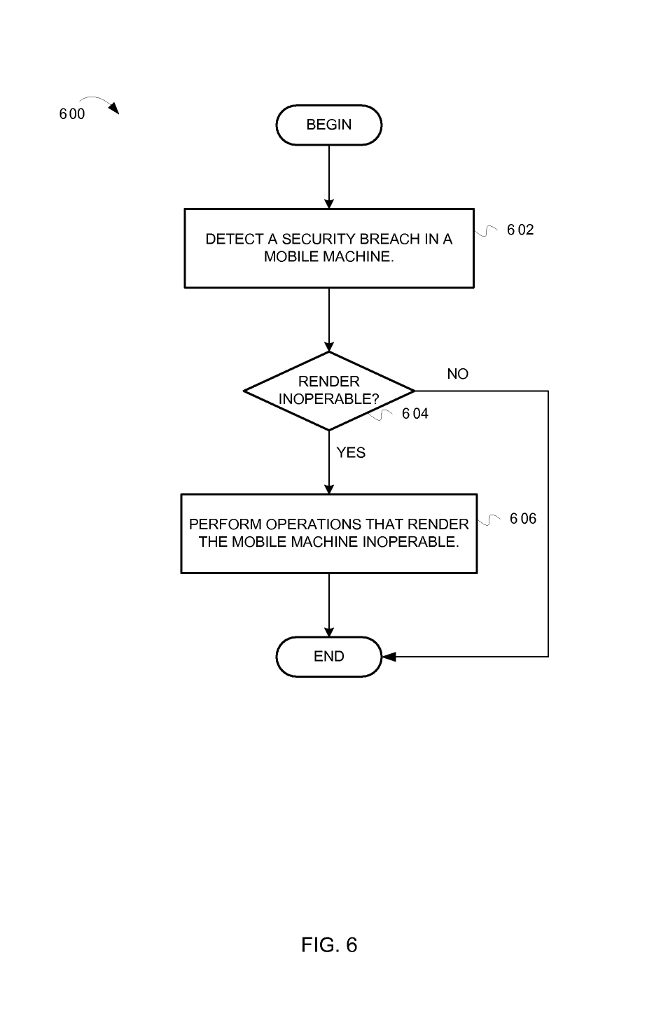

The security module 306 includes a security controller 312, power source 318, memory 314, communication controller 316, and I/O device(s) 310. The security controller 312 is connected to the security sensor 308, which is connected to contacts 326. A fastener 324 holds the contacts 326 together and a shell panel 330 in place. If the fastener 324 is removed, the contacts 326 separate, sending a signal to the security controller 312. The security controller 312 can interpret the signal as an indication that the shell 302 has been compromised. A description of how the security controller 312 responds such signals is set-out below (see discussion of FIG. 6).

The gaming module 304 is enveloped in an enclosure 330. The enclosure 330 can include a conductive mesh or other conductive coating that transmits an electronic signal or interrupts an electronic signal when it has been compromised (e.g., perforated, opened, etc.). The security sensor 308 can detect signals from the enclosure 330 and notify the security controller 312 of any physical compromise of the enclosure 330. The security sensor 308 can also include a photo sensor that notifies the security controller 312 when the shell 302 has been opened in a lighted environment.

In some embodiments, a serpentine wire 320 is wound throughout the shell 302 and connected to the security sensor 308. In some embodiments, the security sensor 308 can sense whether the serpentine wire 320 is damaged. If the serpentine wire 320 is damaged (e.g., by an attempt to drill into the shell 302), the security sensor 308 can notify the security controller 312.

In some embodiments, the contacts 326, enclosure 330, and serpentine wire 320 are connected directly to the security controller 312. As such, some embodiments of the security controller 312 can detect voltage drops and other electrical behavior of the contacts 326, enclosure 330, and/or serpentine wire 320. Based on the electrical behavior, the security controller 312 can detect whether the shell 302 has been compromised.

Some embodiments can include other components that notify the security controller 312 when the shell's physical integrity has been compromised. For example, the shell 302 can include: 1) a photo sensor that notifies the security controller 312 when the shell 302 has been opened in a lighted environment; 2) an impact sensor that notifies the security controller 312 when the shell 302 has sustained an impact exceeding a given force; 3) etc.

### More Gaming Modules

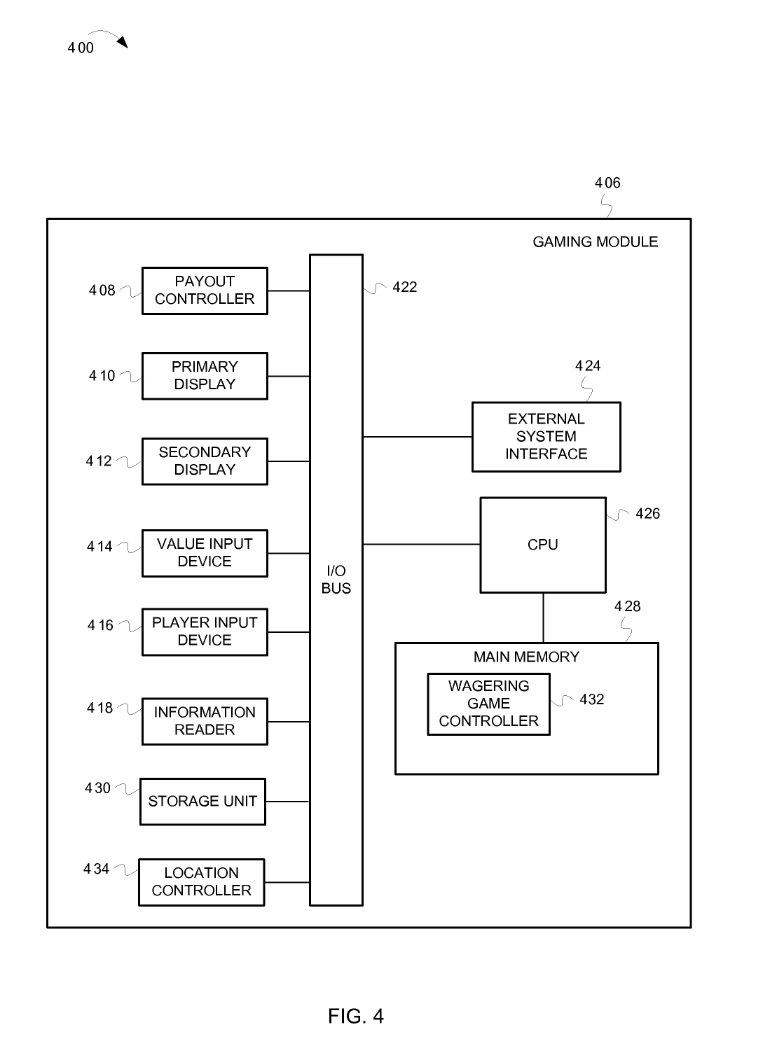

FIG. 4 is a block diagram illustrating a gaming module, according to example embodiments of the invention. As shown in FIG. 4, the gaming module 406 includes a central processing unit (CPU) 426 connected to main memory 428. The CPU 426 can include any suitable processor, such as an Intel® Pentium processor, Intel® Core 2 Duo processor, AMD Opteron™ processor, or UltraSPARC processor. The main memory 428 includes a wagering game controller 432. In one embodiment, the wagering game controller 432 can present wagering games, such as video poker, video black jack, video slots, video lottery, etc., in whole or part.

The CPU 426 is also connected to an input/output (I/O) bus 422, which can include any suitable bus technologies, such as an AGTL+frontside bus and a PCI backside bus. The I/O bus 422 is connected to a payout mechanism 408, primary display 410, secondary display 412, value input device 414, player input device 416, information reader 418, and storage unit 430. The player input device 416 can include the value input device 414 to the extent the player input device 416 is used to place wagers. The I/O bus 422 is also connected to an external system interface 424, which can be connected to external systems (e.g., wagering game networks).

In one embodiment, the gaming module 406 can include additional peripheral devices and/or more than one of each component shown in FIG. 4. For example, in one embodiment, the gaming module 406 can include multiple external system interfaces 424 and/or multiple CPUs 426. In one embodiment, any of the components can be integrated or subdivided.

Any component of the gaming module 406 can include hardware, firmware, and/or machine-readable media including instructions for performing the operations described herein. Machine-readable media includes any mechanism that provides (i.e., stores and/or transmits) information in a form readable by a machine (e.g., a mobile machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 4 describes some embodiments of a gaming module, this section continues with a discussion about adding numerous power sources to gaming modules.

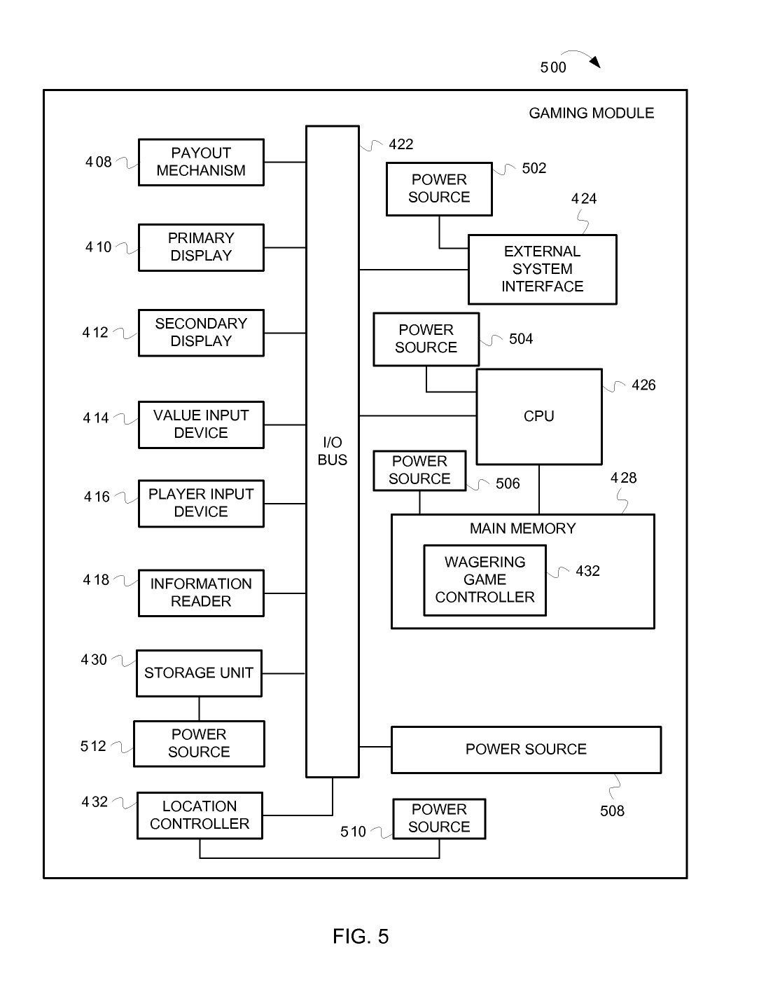

FIG. 5 is a block diagram illustrating a gaming module with multiple power sources, according to some embodiments of the invention. In FIG. 5, the gaming module 500 includes all the components shown in FIG. 4 plus additional power sources. As shown, the gaming module 500 includes: power source 502 connected to the external system interface 424, power source 504 connected to the CPU 426, power source 506 connected to the main memory 428, power source 508 connected to the I/O bus 422, power source 510 connected to the location controller 434, and power source 512 connected to the storage unit 430. The power sources can include one or more lithium ion batteries, nickel-metal hydride batteries, nickel-cadmium batteries, and/or other suitable batteries.

In some embodiments, a component having its own power source can run until its power source is depleted. After depleting its power source, the component remains inoperable until its power source is replenished. For example, after the location controller 434 depletes the power source 510, the location controller 434 becomes inoperable. As a result, the gaming module 500 can still present wagering games even though it cannot track the mobile device's movements.

In some embodiments, the power sources can be embedded in different components. For example, the power source 502 can be embedded in the external system interface 424. As another example, a power source can be thin-mated behind the primary display 410. In some embodiments, the power source 508 can replenish the other power sources.

In some embodiments, the CPU 426 includes multiple processors. When the power source 504 is fully charged, the CPU 426 executes all its processors. As the power source 504 depletes, the CPU 426 can reduce the number of active processors.

In some alternative embodiments, the gaming module 500 does not include the multiple power sources (502, 504, 506, 508, 510, & 512). Instead, the gaming module 500 includes a single multi-component battery whose components independently provide power to the gaming module's components, as similarly described above.

### Example Operations

This section describes operations associated with some embodiments of the invention. In the discussion below, the flow diagrams will be described with reference to the block diagrams presented above. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flow diagram.

### Detecting Security Breaches

This section begins with a description of operations for detecting a security breach and rendering a mobile machine inoperable.

FIG. 6 is a flow diagram illustrating operations for rendering a mobile machine inoperable after detecting a security breach, according to some embodiments of the invention. This section will describe the flow diagram 600 with reference to the mobile machines of FIGS. 2 & 3. The flow begins at block 602.

At block 602, the security controller 216 detects a breach in the mobile machine's security. For example, the security controller 216 detects that the shell has been opened or otherwise damaged (e.g., pried open, drilled, perforated, etc.). In some embodiments, the security controller 216 detects damage to the shell by polling the security sensor(s) 226. In the mobile machine of FIG. 3, the security controller 312 can determine whether the contacts 326, enclosure 330, and/or serpentine wire 320 indicate tampering. Also, the security controller 312 can detect a security breach based on feedback from a photo sensor (e.g., in the security sensor 308). In other embodiments, security controllers can use other sensors and/or equipment to detect breaches in the mobile machine's security. The flow continues at block 604.

At block 604, the security controller 216 determines whether it will render the mobile machine 200 inoperable. In some embodiments, some security breaches are severe enough to cause the security controller 216 to render the mobile machine 200 inoperable, while others are not. For example, the security controller 216 may render the mobile machine 200 inoperable after detecting a perforation in the shell 202, but not after detecting a slight impact. If the security controller 216 will render the mobile machine 200 inoperable, the flow continues at block 606. Otherwise, the flow ends.

At block 606, the security controller 216 performs operations that render the mobile machine 200 inoperable. In some embodiments, operations that render the mobile machine 200 inoperable can include one or more of the following:
The security controller 216 can erase the authentication information 224, which can include a private key, serial number, security credentials, etc. The security controller 216 can erase the authentication information 224 using power from the power source 222. In some embodiment, after the authentication information 224 is erased, the security controller 216 cannot properly authenticate itself with the gaming module 204 and/or a wagering game server. Also, in some embodiments, after private keys are erased, the wagering game controller 210 and/or other components cannot properly encrypt data. In some embodiments, network components (e.g., wagering game servers) will not communication with devices that cannot properly authenticate themselves and/or properly encrypt data.
The security controller 216 can deny access to the authentication information 224 until it receives a reset signal from a technician's station or other network component.
The security controller 216 can use power from the power source 222 to overload its own circuitry (or circuitry of other components), rendering it permanently inoperable. If the security controller 216 is inoperable, it cannot authenticate itself or otherwise respond to the gaming module 204 and/or a wagering game server.
The security controller 216 can erase software executing on the wagering game controller 210, rendering the wagering game controller 210 inoperable.
   In some embodiments, the security controller 216 can perform operations suitable for rendering the mobile machine inoperable. From block 606, the flow ends.

In some embodiments, after a mobile machine has been rendered inoperable, a technician can restore it back to working order. For example, a technician can use secure service equipment to inject authentication information (e.g., a private key) into a mobile machine's security module. Similarly, a technician can use secure service equipment to restore software that was erased as a result of performing the flow 600. Furthermore, technicians can replace components that underwent power overloads and/or other security operations.

### Verifying Mobile Machine Security

In some embodiments, a wagering game server or other network component periodically verifies that a particular mobile machine is secure. In other embodiments, a mobile machine's gaming module or other internal component periodically verifies that the security module has not detected a security breach. FIG. 7 describes operations for verifying mobile machine security.

FIG. 7 is a flow diagram illustrating operations for verifying the physical security of a mobile machine, according to some embodiments of the invention. The flow diagram 700 is described with reference to the mobile machines shown in FIGS. 2 and 3. The flow begins at block 702.

At block 702, the security module's security controller 216 receives a security challenge. The security challenge can be part of a challenge-response technique for verifying the mobile machine's security. The security controller 216 can respond to the security challenge, as described below (see discussion of blocks 706-710). In some embodiments, the security controller 216 can receive the authentication challenge from the gaming module 204 or from the wagering game server 106. The flow continues at block 706.

At block 706, if the mobile machine 200 is secure, the flow continues at block 708. Otherwise, the flow continues at block 710.

At block 708, the security controller 216 responds to the security challenge. In some embodiments, the security controller 216 responds to the security challenge by transmitting a message including a unique serial number and/or other credentials. The security controller 216 can encrypt the message using a private key included in the authentication information 224. The message can be destined for the component that sent the security challenge (e.g., gaming module 204, wagering game server 106, or other wagering game network component). From block 708, the flow ends.

At block 710, the security controller 216 indicates that the mobile machine's security has been compromised. In some embodiments, the security controller 216 indicates a security breach by not responding to the authentication challenge or by sending a message that is not properly encrypted (e.g., because the private key has been erased—see discussion of FIG. 6). In some embodiments, the security controller 216 transmits a message indicating how the mobile machine's security was breached. For example, the message can indicate that the contacts 326 separated or that a photo sensor detected light. From block 710, the flow ends.

### Securing Player Credentials

This section continues with operations for securing player credentials. In some embodiments, a network device authenticates players before allowing them to use mobile machines. The authentication process can require a mobile machine to provide a plurality of player credentials (e.g., an account number and PIN). In some embodiments, different components of the mobile machine receive and encrypt different player credentials. As a result, the player credentials are encrypted using different private keys, making attacks on the player credentials more difficult. FIG. 8 describes this in more detail.

FIG. 8 is a flow diagram illustrating operations for securing player credentials, according to some embodiments of the inventions. The flow diagram 800 begins in parallel at blocks 802 and 808.

At block 802, the security module 216 receives a player credential. In some embodiments, the security module's I/O devices 214 include a player card reader, biometric reader, or other device for reading player credentials. The player credentials can include an account number, biometric information, and/or other information. The flow continues at block 804.

At block 804, the security module 216 encrypts the player credential. For example, the security controller 216 can encrypt a player account number using a private key stored in the authentication information 224. In some embodiments, the security module's private key periodically changes. The flow continues at block 806.

At block 806, the security module 216 passes the encrypted player credential for use in an authentication process. For example, the security module 216 can pass the encrypted player credential to the gaming module's authentication controller 230, which in turn passes it to a wagering game server. In other embodiments, the security module 216 itself passes the encrypted player credential to the wagering game server or other network components. The wagering game server or other network component can use the encrypted player credential to authenticate a player. From block 806, the flow ends.

At block 808, the gaming module's authentication controller 230 receives another player credential. For example, the gaming module's I/O devices 208 include a touchscreen that receives player input indicating a personal identification number (PIN). The flow continues at block 810.

At block 810, the authentication controller 230 encrypts the player credential using a private key different from the security controller's private key. The flow continues at block 812.

At block 812, the authentication controller 230 passes the second encrypted player credential for use in an authentication process. In some embodiments, the security module 216 passes both encrypted player credentials to a wagering game server or other network component, which can use the credentials to authenticate a player. In other embodiments, the authentication controller 230 passes only the player credential received at block 808. From block 812, the flow ends.

Because the mobile machine 200 can process player credentials using a plurality of components, attackers have to compromise a plurality of components to acquire the plurality of player credentials.

### More About Mobile Machines

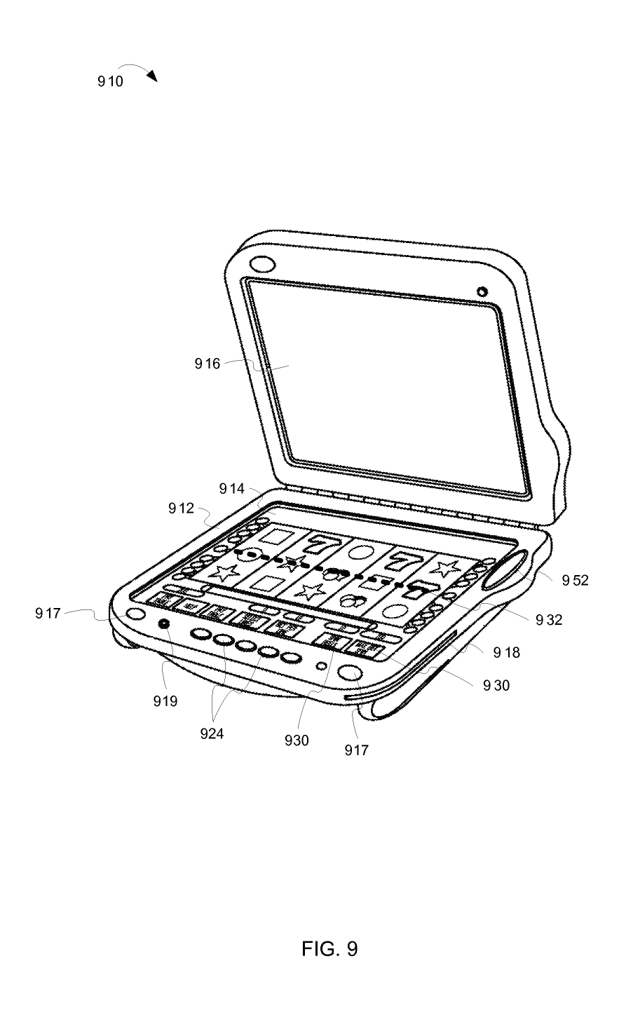

FIG. 9 shows an example embodiment of a mobile machine. Like large cabinet-type wagering game machines, the mobile machine 910 can include any suitable electronic device configured to play a video casino games such as blackjack, slots, keno, poker, blackjack, and roulette. The mobile machine 910 comprises a housing 912 and includes input devices, including a value input device 918 and a player input device 924. For output, the mobile machine 910 includes a primary display 914, a secondary display 916, one or more speakers 917, one or more player-accessible ports 919 (e.g., an audio output jack for headphones, a video headset jack, etc.), and other conventional I/O devices and ports, which may or may not be player-accessible. In the embodiment depicted in FIG. 9, the mobile machine 910 comprises a secondary display 916 that is rotatable relative to the primary display 914. The optional secondary display 916 can be fixed, movable, and/or detachable/attachable relative to the primary display 914. Either the primary display 914 and/or secondary display 916 can be configured to display any aspect of a non-wagering game, wagering game, secondary game, bonus game, progressive wagering game, group game, shared-experience game or event, game event, game outcome, scrolling information, text messaging, emails, alerts or announcements, broadcast information, subscription information, and mobile machine status.

The player-accessible value input device 918 can comprise, for example, a slot located on the front, side, or top of the casing 912 configured to receive credit from a stored-value card (e.g., casino card, smart card, debit card, credit card, etc.) inserted by a player. The player-accessible value input device 918 can also comprise a sensor (e.g., an RF sensor) configured to sense a signal (e.g., an RF signal) output by a transmitter (e.g., an RF transmitter) carried by a player. The player-accessible value input device 918 can also or alternatively include a ticket reader, or barcode scanner, for reading information stored on a credit ticket, a card, or other tangible portable credit or funds storage device. The credit ticket or card can also authorize access to a central account, which can transfer money to the mobile machine 910.

Still other player-accessible value input devices 918 can require the use of touch keys 930 on the touch-screen display (e.g., primary display 914 and/or secondary display 916) or player input devices 924. Upon entry of player identification information and, preferably, secondary authorization information (e.g., a password, PIN number, stored value card number, predefined key sequences, etc.), the player can be permitted to access a player's account. As one potential optional security feature, the mobile machine 910 can be configured to permit a player to only access an account the player has specifically set up for the mobile machine 910. Other conventional security features can also be utilized to, for example, prevent unauthorized access to a player's account, to minimize an impact of any unauthorized access to a player's account, or to prevent unauthorized access to any personal information or funds temporarily stored on the mobile machine 910.

The player-accessible value input device 918 can itself comprise or utilize a biometric player information reader which permits the player to access available funds on a player's account, either alone or in combination with another of the aforementioned player-accessible value input devices 918. In an embodiment wherein the player-accessible value input device 918 comprises a biometric player information reader, transactions such as an input of value to the mobile machine 910, a transfer of value from one player account or source to an account associated with the mobile machine 910, or the execution of another transaction, for example, could all be authorized by a biometric reading, which could comprise a plurality of biometric readings, from the biometric device.

Alternatively, to enhance security, a transaction can be optionally enabled only by a two-step process in which a secondary source confirms the identity indicated by a primary source. For example, a player-accessible value input device 918 comprising a biometric player information reader can require a confirmatory entry from another biometric player information reader 952, or from another source, such as a credit card, debit card, player ID card, fob key, PIN number, password, hotel room key, etc. Thus, a transaction can be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 918 can be provided remotely from the mobile machine 910.

The player input device 924 comprises a plurality of push buttons on a button panel for operating the mobile machine 910. In addition, or alternatively, the player input device 924 can comprise a touch screen mounted to a primary display 914 and/or secondary display 916. In one aspect, the touch screen is matched to a display screen having one or more selectable touch keys 930 selectable by a user's touching of the associated area of the screen using a finger or a tool, such as a stylus pointer. A player enables a desired function either by touching the touch screen at an appropriate touch key 930 or by pressing an appropriate push button on the button panel. The touch keys 930 can be used to implement the same functions as push buttons. Alternatively, the push buttons 926 can provide inputs for one aspect of the operating the game, while the touch keys 930 can allow for input needed for another aspect of the game. The various components of the mobile machine 910 can be connected directly to, or contained within, the casing 912, as seen in FIG. 9, or can be located outside the casing 912 and connected to the casing 912 via a variety of wired (tethered) or wireless connection methods. Thus, the mobile machine 910 can comprise a single unit or a plurality of interconnected (e.g., wireless connections) parts which can be arranged to suit a player's preferences.

The operation of the basic wagering game on the mobile machine 910 is displayed to the player on the primary display 914. The primary display 914 can also display the bonus game associated with the basic wagering game. The primary display 914 preferably takes the form of a high resolution LCD, a plasma display, an LED, or any other type of display suitable for use in the mobile machine 910. The size of the primary display 914 can vary from, for example, about a 2-3″ display to a 15″ or 17″ display. In at least some embodiments, the primary display 914 is a 7″-10″ display. In one embodiment, the size of the primary display can be increased. Optionally, coatings or removable films or sheets can be applied to the display to provide desired characteristics (e.g., anti-scratch, anti-glare, bacterially-resistant and anti-microbial films, etc.). In at least some embodiments, the primary display 914 and/or secondary display 916 can have a 16:9 aspect ratio or other aspect ratio (e.g., 4:3). The primary display 914 and/or secondary display 916 can also each have different resolutions, different color schemes, and different aspect ratios.

As with the free standing embodiments a wagering gaming machine, a player begins play of the basic wagering game on the mobile machine 910 by making a wager (e.g., via the value input device 918 or an assignment of credits stored on the handheld gaming machine via the touch screen keys 930, player input device 924, or buttons 926) on the mobile machine 910. In some embodiments, the basic game can comprise a plurality of symbols arranged in an array, and includes at least one payline 932 that indicates one or more outcomes of the basic game. Such outcomes can be randomly selected in response to the wagering input by the player. At least one of the plurality of randomly selected outcomes can be a start-bonus outcome, which can include any variations of symbols or symbol combinations triggering a bonus game.

In some embodiments, the player-accessible value input device 918 of the mobile machine 910 can double as a player information reader 952 that allows for identification of a player by reading a card with information indicating the player's identity (e.g., reading a player's credit card, player ID card, smart card, etc.). The player information reader 952 can alternatively or also comprise a bar code scanner, RFID transceiver or computer readable storage medium interface. In one embodiment, the player information reader 952 comprises a biometric sensing device.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Some embodiments of the invention can include any combination of features described above. While some embodiments are not shown, they are included within the inventive subject matter, as logical, mechanical, electrical, and other changes can be made to the example embodiments described herein. Features of various embodiments described herein, however essential to some example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A mobile wagering game machine comprising:
a shell configured to contain components of the mobile wagering game machine, the components including,
one or more sensors configured to detect and report physical alterations of the shell;
a security controller configured to
detect reports of physical alterations of the shell from the one or more sensors;
disable, based one or more of the reports, the wagering game machine;
receive a first player credential and forward the first player credential to a wagering game server for authentication;
a gaming module including,
an authentication controller configured to
receive a second player credential and forward the second player credential to the wagering game server for authentication, and to receive an authentication confirmation from the wagering game server;
a wagering game controller configured to receive
wagering game results, from the wagering game server and to present the wagering game results.

2. The mobile wagering game machine of 1, wherein the security controller is molded into the shell, and wherein the security controller includes a card reader configured to read the first player credential from a card inserted in the card reader.

3. The mobile wagering game machine of 1, wherein the one or more sensors include one or more of a serpentine wire molded into the shell, contacts, and light sensors.

4. The mobile wagering game machine of 1, wherein the authentication confirmation is based on the first and second player credentials.

5. The mobile wagering game machine of 1, wherein the gaming module is encased in a conductive mesh envelope configured to detect tampering with the gaming module, wherein the conductive mesh envelope is connected to the one or more sensors.

6. The mobile wagering game machine of 1, wherein the security controller is further configured to encrypt the first player credential with a first private encryption key, and wherein the authentication controller is further configured to encrypt the second player credential with a second private encryption key.

7. A method for securing a mobile wagering game machine, the method comprising:
receiving player credentials in the mobile wagering game machine;
encrypting, in the mobile wagering game machine, the player credentials using one or more private encryption keys;
transmitting, over a wagering game network, the player credentials for authentication;
receiving, in the mobile wagering game machine, an indication that the player credentials are authentic;
presenting one or more wagering games after receipt of the indication that the player credentials are authentic, wherein the presenting includes,
receiving results of the one or more wagering games from a wagering game server; and
displaying the results on one or more display devices;
detecting, from one or more sensors in the mobile wagering game machine, indications that an enclosure of the mobile wagering game machine has been breached; and
applying an overload of power to components in the mobile wagering game machine, wherein the overload of power disables the mobile wagering game machine from presenting more wagering games.

8. The method of claim 7, wherein the receiving player credentials includes,
reading a player identifier from a player card; and
detecting entry of a personal identifier number.

9. The method of claim 7 further comprising:
receiving, in the mobile wagering game machine, an indication that the player credentials are not authentic;
deleting, after receipt of the indication that the player credentials are not authentic, the one or more private encryption keys.

10. The method of claim 9 further comprising:
receiving, over a secure connection to a service station, new private encryption keys, wherein the receiving occurs after the deleting.

11. The method of claim 7, wherein the overload of power originates from a first power source not used for powering the presentation of the one or more wagering games.

12. A system comprising:
a mobile wagering game machine including a shell, the shell including,
a gaming module including machine-executable code stored on a tangible medium, the code configured to cause the gaming module to
receive a first player credential and a second player credential;
transmit the first and second player credentials for authentication;
receive an indication that the first and second player credentials are authentic; and
present wagering games after receipt of the indication that the player credentials are authentic;
a security module configured to
detect input including the first player credential;
transmit the first player credential to the gaming module;
detect a breach of the shell; and
erase, after detection of the breach, the code included in the gaming module;
a service station configured to interface with the mobile wagering game machine and to
load a replacement copy of the code onto the mobile wagering game machine; and
a wagering game server configured to
receive the first and second player credentials from the mobile wagering game machine;
verify authenticity of the first and second player credentials;
provide, to the mobile wagering game machine, the indication that the first and second player credentials are authentic; and
provide, to the mobile wagering game machine, results for the wagering games.

13. The system of claim 12, wherein the shell further includes a wire mesh enveloping the gaming module, wherein the wire mesh is configured to indicate a breach of the shell to the security module.

14. The system of claim 12, wherein
the gaming module is further configured to encrypt the first and second player credentials based on a private encryption key;
and wherein the security module is further configured to erase the private encryption key after detection of the breach.

15. The system of claim 14, wherein the service station is further configured to inject another private encryption key into the mobile wagering game machine.
